(19) United States
(12) Patent Application Publication
(10) Pub. No.: US 2021/0335345 A1
(43) Pub. Date: Oct. 28, 2021

(54) Real Time Audio Profanity Filter

(71) Applicants: Kathy-Ann Cameron-Kidd, Redford, MI (US); Michael Kidd, Redford, MI (US)

(72) Inventors: Kathy-Ann Cameron-Kidd, Redford, MI (US); Michael Kidd, Redford, MI (US)

(21) Appl. No.: 16/856,308

(22) Filed: Apr. 23, 2020

(51) Int. Cl. G10L 15/10; G10L 15/26; G10L 15/00; G06F 3/16

(52) U.S. Cl. CPC G10L 15/10; G10L 15/26; G10L 2015/088; G06F 3/165; G10L 15/005

(57) ABSTRACT

A computer program product, method and a system for a profanity filter includes a discrete device engineered with a communications port and a plurality of intraconnected digital signal processing modules. A language of origin text generation (TG) module configured to generate text from an audio language of origin is included. Also a profanity match (PM) module is configured to match a text list of defined profanity with profanity in the generated text. Furthermore, a profanity replacement (PR) module is configured to replace the matching profanity with an antiprofanity equivalent. The profanity filter device comprises an emoji face design, a clam shell and a box design with HDMI and USB ports. The disclosure filters profanity from TV shows, movies and any audio feed. The device also connects to the TV screen, computer monitor, or other video entertainment device for the purpose of instantly and automatically filtering profanity while the user listens.

### BACKGROUND

Analyses of recorded conversations reveal that an average of roughly 80-90 words that a person speaks each day—0.5% to 0.7% of all words—are swear words, with usage varying from 0% to 3.4%. In comparison, first-person plural pronouns (we, us, our) make up 1% of spoken words.

A three-country poll conducted by Angus Reid Public Opinion in July 2010 found that Canadians swear more often than Americans and British when talking to friends, while Britons are more likely than Canadians and Americans to hear strangers swear during a conversation.

Swearing performs certain psychological functions, and uses particular linguistic and neurological mechanisms; all these are avenues of research. Functionally similar behavior can be observed in chimpanzees, and may contribute to our understanding. It is noted that swearing is a widespread but perhaps underappreciated anger management technique; that “Men generally curse more than women, unless said women are in a sorority, and that university provosts swear more than librarians or the staff members of the university day care center”. Swearing over time may gain roots as a habit with involuntary utterance of obscene words or socially inappropriate and derogatory remarks. This has been referred to as coprolalia, which is an occasional characteristic of tic disorders.

Researchers have found that swearing relieves the effects of physical pain. One Researcher said, “I would advise people, if they hurt themselves, to swear”. However, the overuse of swear words tends to diminish this effect. This research team won the Ig Nobel Peace Prize in 2010 for their research.

A team of neurologists and psychologists at the UCLA Easton Center for Alzheimer's Disease Research suggested that swearing may help differentiate Alzheimer's disease from frontotemporal dementia. A Neurologist noted that despite loss of language due to damage to the language areas of the brain, patients were still often able to swear.

A group of researchers from Wright State University studied why people swear in the online world by collecting tweets posted on Twitter. They found that cursing is associated with negative emotions such as sadness (21.83%) and anger (16.79%) thus showing people in the online world mainly use curse words to express their sadness and anger towards others.

An interdisciplinary team of researchers from the University of Warsaw investigated bilingual swearing: why is it easier to swear in a foreign language? Their finding that bilinguals strengthen the offensiveness of profanities when they switch into their second language, but soften it when they switch into their first tongue, but do both statistically significantly only in the case of ethnophauli sins (ethnic slurs) led the scientist to the conclusion that switching into the second language exempts bilinguals from the social norms and constraints (whether own or socially imposed) such as political correctness, and makes them more prone to swearing and offending others.

### SUMMARY OF THE INVENTION

A disclosed profanity filter comprises a discrete device engineered with a communications port and a plurality of intraconnected digital signal processing modules including the following. A language of origin text generation (TG) module configured to generate text from an audio language of origin is included. Also a profanity match (PM) module is configured to match a text list of defined profanity with profanity in the generated text. Furthermore, a profanity replacement (PR) module is configured to replace the matching profanity with an antiprofanity equivalent.

### BRIEF DESCRIPTION OF THE DRAWINGS

FIG. 1 is a perspective depiction of the disclosed discrete profanity filter box with USB or HDMI ports in accordance with an embodiment of the present disclosure.

FIG. 2 is a perspective depiction of the disclosed discrete profanity emoiji design with USB or HDMI ports in accordance with an embodiment of the present disclosure.

FIG. 3 is a perspective depiction of the disclosed discrete profanity seashell design with USB or HDMI ports in accordance with an embodiment of the present disclosure.

FIG. 4 is a flow chart of a method of filtering profanity in accordance with an embodiment of the present disclosure.

FIG. 5 is a block diagram of the profanity filter system and computer program product in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The present invention is an automatic profanity filter that plugs into any media device via an USB or HDMI cord. The automatic profanity filter comes in different shapes and colors.

Throughout the present disclosure the term ‘machine translation’ is applied in the common sense to a translation done by a digital computer or workstation processor. The term ‘translation’ refers to a voiced or electronical sound production of either a computer translation or a human interpretation.

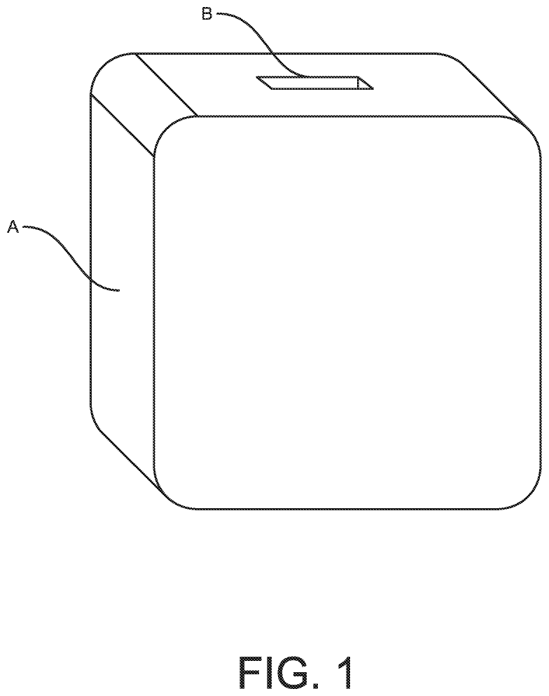

FIG. 1 is a perspective depiction of the disclosed discrete profanity filter box with USB or HDMI ports in accordance with an embodiment of the present disclosure. The box A houses the digital signal processors and components of the disclosed profanity filter. Additionally, a USB/HDMI port B enables connection to a set top VCR/Cable box and to a computer and other personal digital assistant device for filtering profanity.

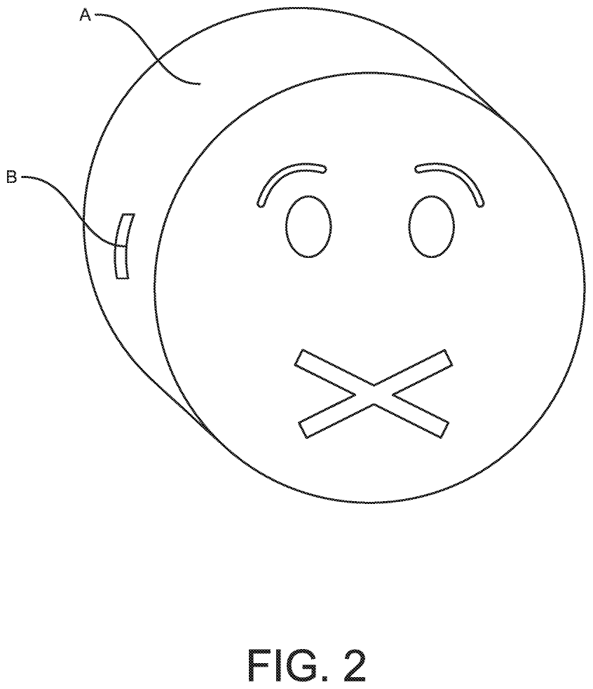

FIG. 2 is a perspective depiction of the disclosed discrete profanity emoiji design with USB or HDMI ports in accordance with an embodiment of the present disclosure. The box A houses the digital signal processors and components of the disclosed profanity filter. Additionally, a USB/HDMI port B enables connection to a set top VCR/Cable box and to a computer and other personal digital assistant device for filtering profanity.

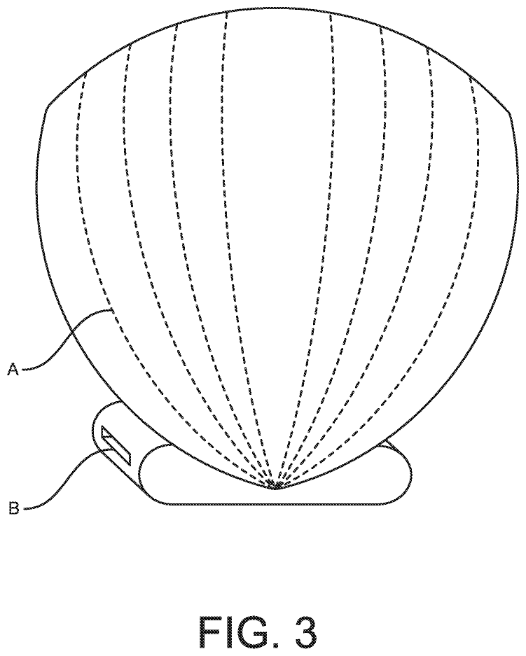

FIG. 3 is a perspective depictionof the disclosed discrete profanity seashell design with USB or HDMI ports in accordance with an embodiment of the present disclosure. The box A houses the digital signal processors and components of the disclosed profanity filter. Additionally, a USB/HDMI port B enables connection to a set top VCR/Cable box and to a computer and other personal digital assistant device for filtering profanity.

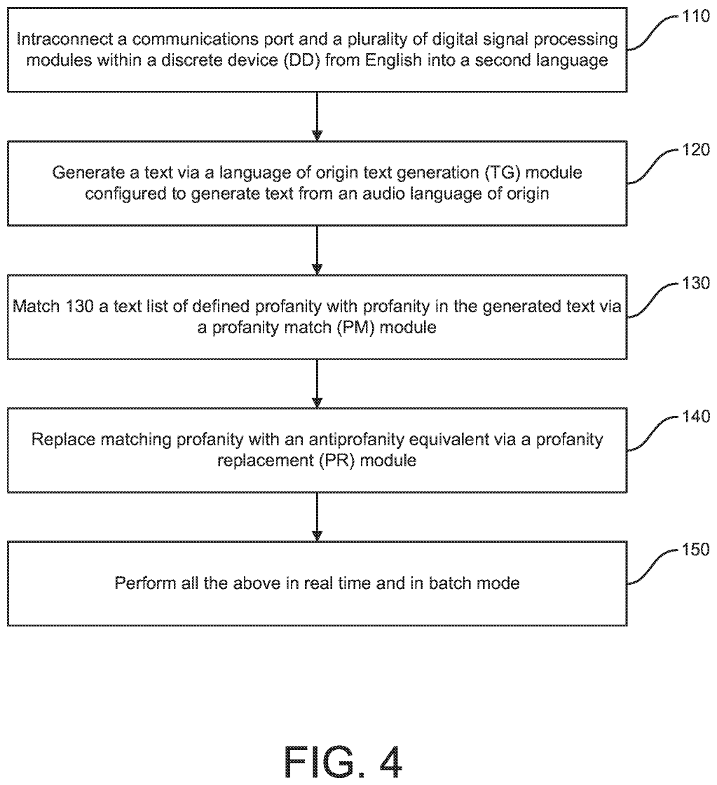

FIG. 4 is a flow chart of a method of filtering profanity in accordance with an embodiment of the present disclosure. The profanity filter method includes intraconnecting 110 a communications port and a plurality of digital signal processing modules within a discrete device (DD). The method also includes generating 120 a text via a language of origin text generation (TG) module configured to generate text from an audio language of origin. The method additionally includes matching 130 a text list of defined profanity with profanity in the generated text via a profanity match (PM) module. The method further includes replacing 140 matching profanity with an antiprofanity equivalent via a profanity replacement (PR) module. The method yet includes performing the above in real time and in batch mode 150.

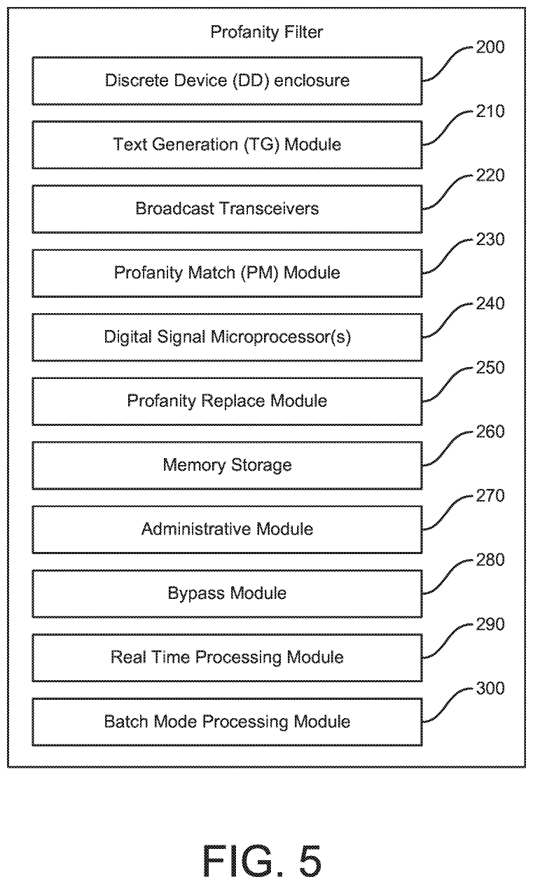

FIG. 5 is a block diagram of the profanity filter system and computer program product in accordance with an embodiment of the present disclosure. The depiction includes a discrete device 200 enclosure, a text generation module 210, broadcast transceivers 220, profanity match modules 230, digital signal processing modules 240, profanity replacement modules 250, memory storage modules 260, administrative modules 270, a bypass module 280, a real time processing module 290 and a batch mode processing module 300. The bypass module 280 allows a user to listen to an audio program with profanity unfiltered. The profanity replacement module 230 replaces the matched profanity into the original audio stream or language of origin, with a synonym, a bleep, a silence or a matching profanity in a different language.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein in a non-provisional specification to follow.

What is claimed is:

1. A profanity filter, comprising:
a discrete device comprising a communications port and a plurality of intraconnected digital signal processing modules including;
a language of origin text generation (GT) module configured to generate text from an audio language of origin;
a profanity match (PM) module configured to match a text list of defined profanity with profanity in the generated text;
a profanity replacement (PR) module configured to replace the matching profanity with an antiprofanity equivalent.

2. The profanity filter of claim 1, wherein an audio language of origin includes spoken languages of the world including English, Spanish, French, German, Mandarin Chinese, Cantonese, Portuguese, Korean, Japanese, Italian, and other languages.

3. The profanity filter of claim 1, wherein the communications port comprises a wired and a wireless transceiver.

4. The profanity filter of claim 1, wherein the PM module is a script configured to match a profane word in the text list with a similar and same word from the GT module.

5. The profanity filter of claim 1, further comprising a memory storage (MS) for the defined profanity text list.

6. The profanity filter of claim 1, further comprising an administrative (AM) module configured to process an input from a user via the communications port.

7. The profanity filter of claim 1, further comprising an emoji face design for the discrete device.

8. The profanity filter of claim 1, wherein the digital signal processing modules are configured to process in real time and in batch mode.

9. The headphones of claim 1, further comprising a clam shell design and a box design for the discrete device.

10. A computer program product comprising a computer readable medium having computer useable code executable to perform operations for filtering profanity, the operations of the computer program product comprising:
intraconnecting a communications port and a plurality of digital signal processing modules within a discrete device;
generating a text via a language of origin text generation (TG) module configured to generate text from an audio language of origin;
matching a text list of defined profanity with profanity in the generated text via a profanity match (PM) module configured to match;
replacing matching profanity with an antiprofanity equivalent via a profanity replacement (PR) module.

11. The computer program product of claim 10, further comprising executing a script configured for matching a profane word in the text list with a similar and same word from the GT module.

12. The computer program product of claim 10, further comprising streaming both an original audio and a profanity filtered audio on a plurality of audio channels available to a user via the device.

13. The computer program product of claim 10, further comprising further comprising receiving a profanity list input from a user via the communications port.

14. A profanity filter method comprising:
intraconnecting a communications port and a plurality of digital signal processing modules within a discrete device;
generating a text via a language of origin text generation (TG) module configured to generate text from an audio language of origin;
matching a text list of defined profanity with profanity in the generated text via a profanity match (PM) module configured to match;
replacing matching profanity with an antiprofanity equivalent via a profanity replacement (PR) module.

15. The method of claim 14, further comprising communicating with other devices via a wired and a wireless communications port circuitry in the profanity filter.

16. The method of claim 14, further comprising executing a script configured for matching a profane word in the text list with a similar and same word from the GT module.

17. The method of claim 14, further comprising a memory storage (MS) for the defined profanity text list.

18. The method of claim 14, further comprising administering an input from a user via the communications port.

19. The method of claim 14, further comprising processing in real time and in batch mode the digital signal processing modules.

20. The method of claim 14, further comprising streaming both an original audio and a filtered audio on a plurality of audio channels available to a user via the device.
